(19) United States
(12) Patent Application Publication
(10) Pub. No.: US 2016/0178805 A1
(43) Pub. Date: Jun. 23, 2016

(54) LENS ASSEMBLY AND CAMERA MODULE INCLUDING THE SAME

(71) Applicant: SAMSUNG ELECTRO-MECHANICS CO., LTD., Suwon-si (KR)

(72) Inventors: Young Suk KANG, Suwon-si (KR); Tae Kwon KWON, Suwon-si (KR)

(73) Assignee: SAMSUNG ELECTRO-MECHANICS CO., LTD., Suwon-si (KR)

(21) Appl. No.: 14/966,361

(22) Filed: Dec. 11, 2015

(30) Foreign Application Priority Data
Dec. 19, 2014 (KR) 10-2014-0184612

(51) Int. Cl. G02B 1/11; G02B 5/00; G02B 7/00; G02B 7/02

(52) U.S. Cl. CPC G02B 1/11; G02B 7/021; G02B 5/003; G02B 7/026; G02B 7/006

(57) ABSTRACT

A lens assembly having a lens barrel having an internal space. The lenses are stacked in the internal space of the lens barrel. Each of the lenses has an effective portion and a rib extending in a radial direction from an outer radial edge of the effective portion; and a blocking part is provided on an axial surface of at least one rib.

### CROSS-REFERENCE TO RELATED APPLICATION(S)

This application claims the benefit under 35 U.S.C. §119(A) of Korean Patent Application No. 10-2014-0184612 filed on Dec. 19, 2014, in the Korean Intellectual Property Office, the entire disclosure of which is incorporated herein by reference for all purposes.

### BACKGROUND

1. Field

The following description relates to a lens assembly and a camera module including the same.

2. Description of Related Art

Camera modules have been used in personal portable terminals such as mobile phones, personal digital assistants (PDAs), or the like. In such camera modules, a plurality of lenses are stacked in and coupled to a cylindrical barrel along an optical axis, and an optical filter and an image sensor may be coupled to lower portions of the lens barrel and the lenses in a housing.

In a camera module, when light from a fluorescent lamp is incident to the camera module or intense light is incident to the camera module at a predetermined angle in a dark environment, light at a specific angle is internally reflected on rib surfaces of the lenses accommodated in the lens barrel. The internally reflected light, which is not associated with image formation, causes a flare or ghost phenomenon.

Therefore, the necessity to block light incident to an image formation surface of an image sensor through internal reflection on the rib surfaces of the lenses has increased.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens assembly that can block incidence of light to an image formation surface of an image sensor through internal reflection by rib surfaces of lenses, and a camera module including the same.

In another general aspect, a lens assembly includes a lens barrel having an internal space. The lenses are stacked along an optical axis in the internal space of the lens barrel. Each of the lenses has an effective portion and a rib extending in a radial direction from an outer radial edge of the effective portion. A blocking part is provided on an axial surface of at least one of the ribs of the lens stack. The internal reflection of light incident to the rib surface of the lens is prevented by the blocking part. The blocking part may be formed of matte ink and may be formed by either an inkjet printing method or a laser printing method.

In another general aspect, a camera module includes: an image sensor having an image formation surface receiving light passing through the lenses; and a housing accommodating the lens barrel therein.

In another general aspect, a method of preventing internal reflections of light in a lens assembly includes stacking two lenses along an optical axis in a lens barrel, wherein each of the lenses has an effective portion and a rib extending radially from the effective portion; and coating an axial surface of each rib with a light absorbing material.

Other features and aspects will be apparent from the following detailed description, the drawings, and the claims.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view of a lens assembly;

FIG. 2 is an isometric cross-sectional view of the lens assembly, illustrating an example of a lens assembly of FIG. 1;

FIG. 3 is a cross-sectional view illustrating an example of an operation of blocking parts of the lens assembly, blocking internal reflection by rib surfaces of lenses in a case in which light is incident to the lens assembly at an angle of 45 degrees;

FIG. 4 is a cross-sectional view illustrating an example of an operation of blocking parts of the lens assembly, blocking internal reflection by rib surfaces of lenses in a case in which light is incident to the lens assembly at an angle of 50 degrees;

FIG. 5 is an isometric cross-sectional view of a camera module;

FIG. 6 is a cross-sectional view illustrating an example of an operation of blocking parts of the camera module of FIG. 5, blocking internal reflection by rib surfaces of lenses in a case in which light is incident to the camera module at an angle of 45 degrees; and

FIG. 7 is a cross-sectional view illustrating an example of an operation of blocking parts of the camera module of FIG. 5, blocking internal reflection by rib surfaces of lenses in a case in which light is incident to the camera module at an angle of 50 degrees.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

In the drawings, the shapes and dimensions of elements may be exaggerated for clarity, and the same reference numerals will be used throughout to designate the same or like elements.

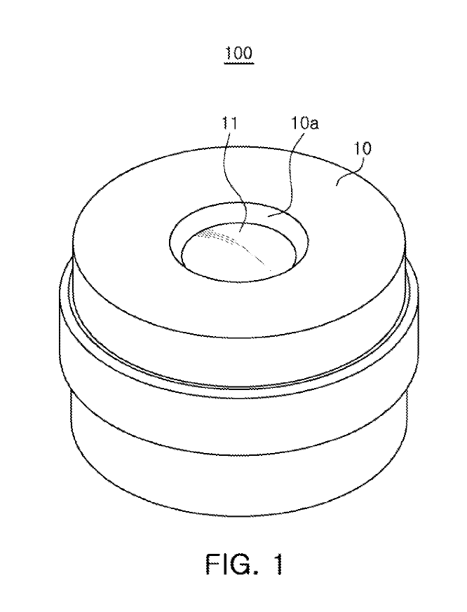

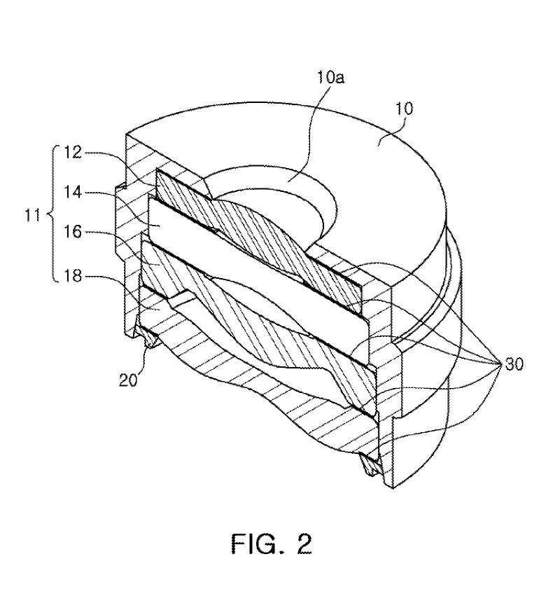

FIG. 1 is a schematic perspective view of a lens assembly according to an exemplary embodiment, and FIG. 2 is a cross-sectional view of the lens assembly according to an exemplary embodiment.

Referring to FIGS. 1 and 2, a lens assembly 100 includes a lens barrel 10 including an internal space, one or more lenses 11 stacked in the internal space, blocking parts 30 provided on outer surfaces of the lenses, and a press-fitting ring, or a lock ring, 20 fixing the lenses 11 in the barrel 10. The lens barrel 10 includes the internal space having a predetermined size, and one or more lenses 11 are arranged along an optical axis in the internal space. That is, the lens barrel 10 has a cylindrical shape having a hollow part, and a lens hole 10a formed in an upper surface thereof to penetrate therethrough in order to transmit light therethrough.

A number of the lenses 11 provided in the lens barrel 10 are stacked along the optical axis A depending on a design of the lens assembly 100, and may have optical characteristics such as the same refractive index or different refractive indices. Each of the lenses 11 include an effective portion 40 formed on a central portion of the lens and a rib portion, or rib, 50 extending from an edge of the effective portion in a radial direction, wherein the effective portion 40 and rib 50 have axial surfaces. The effective portion refracts incoming light rays and the rib portion contacts an adjacent lens, the lens barrel, or both, and supports the effective portion of the lens. Each effective portion has an upper effective surface and a lower effective surface. Additionally, each rib 50 has an upper surface and a lower surface. The upper effective surface corresponds to a surface of the lens on the lens hole side. The lower effective surface corresponds to a surface of the lens opposite the upper effective surface. Similarly, the upper rib surface corresponds to a surface of the lens on the lens hole side and the lower rib surface corresponds to a surface of the lens opposite the upper rib surface. Here, the radial direction refers to a direction from the center of the lens hole 10a toward an outer peripheral surface of the lens barrel (see FIG. 1).

The number of lenses 11 provided in the lens barrel 10 may be variously modified. However, hereinafter, the lenses 11 include first to fourth lenses 12, 14, 16, and 18 will be described by way of example. The lens barrel 10 may further include an actuator (not illustrated) that moves the lenses 11 in an optical axis direction when power is applied thereto. The actuator may have various forms, for example, a voice coil motor (VCM) using a magnet and a coil, effecting movement of the lenses by electromagnetic force generated by an interaction between an electrical field generated by applying power to the coil and a magnetic field of the magnet; or a piezoelectric actuator using a piezoelectric body and effecting movement of the lenses by deformation of the piezoelectric body when power is applied to the piezoelectric body.

Spacers (not illustrated) may be disposed between the lenses 11 in order to adjust gaps between the lenses. The spacers include holes formed in central portions thereof and are larger than outer diameters of the effective portions so that image light passes therethrough, and sizes and shapes of the spacers corresponds to those of the lenses 11. However, the gaps between the lenses may be adjusted by adjusting sag values of the lenses or adjusting thicknesses of the ribs 50 of the lenses instead of the spacers. That is, the gaps between the lenses may be adjusted by omitting the spacers and forming the ribs 50 rat thicknesses corresponding to those of the spacers, or by adjusting sag values of the plurality of lenses 11.

The press-fitting ring 20, which is provided in order to prevent the lenses 11 from being separated outwardly from the lens barrel 10, is inserted into and coupled to an inner portion of the lens barrel 10. The press-fitting ring 20 is inserted into an opening of the lens barrel 10 to contact a rib surface of the lens 11 provided at the outermost portion of the lens barrel 10 and an inner peripheral surface of the lens barrel 10. In addition, an adhesive may be applied between the press-fitting ring 20 and the lens barrel 10, and the press-fitting ring 20 may be closely adhered and fixed to the inner portion of the lens barrel 10 by curing the adhesive.

The blocking parts 30, which are provided to prevent a flare phenomenon in which quality of resolution is decreased, are formed on the rib surfaces of the lenses 11 accommodated in the lens barrel 10. That is, light incident to the lenses 11 at a predetermined angle may be internally reflected on the rib surfaces of the lenses 11 and then be incident to an image formation surface of an image sensor 70 to be described below. The light may form noise on the image formation surface decreasing resolution. That is, the blocking parts 30 preventing internal reflection are formed on the rib surfaces of the lenses 11 to block the light incident to the image formation surface of the image sensor 70. The blocking parts 30 may be formed of a light absorbing material, such as matte ink, and may be applied onto the rib surfaces of the lenses 11 by an inkjet printing method or a laser printing method.

The matte ink forming the blocking part 30 may be of any material that blocks light reflection, such as a carbon based material (a graphene oxide or diamond line carbon (DLC)), a chrome based oxide (CrO or CrO₂), a copper based oxide (CuO), a manganese based oxide (MnO₂), a cobalt based oxide (CoO), a cobalt based sulfide (CoS₂ or Co₃S₄), and a nickel based oxide (Ni₂O₃).

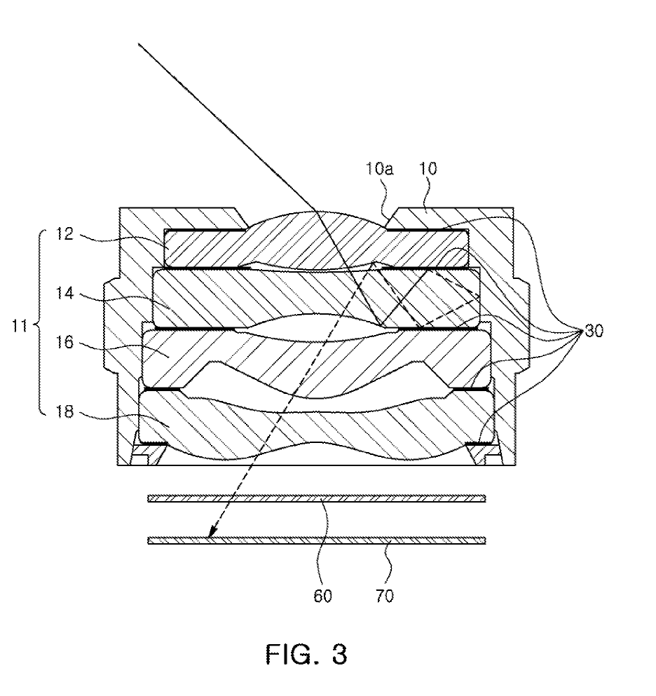

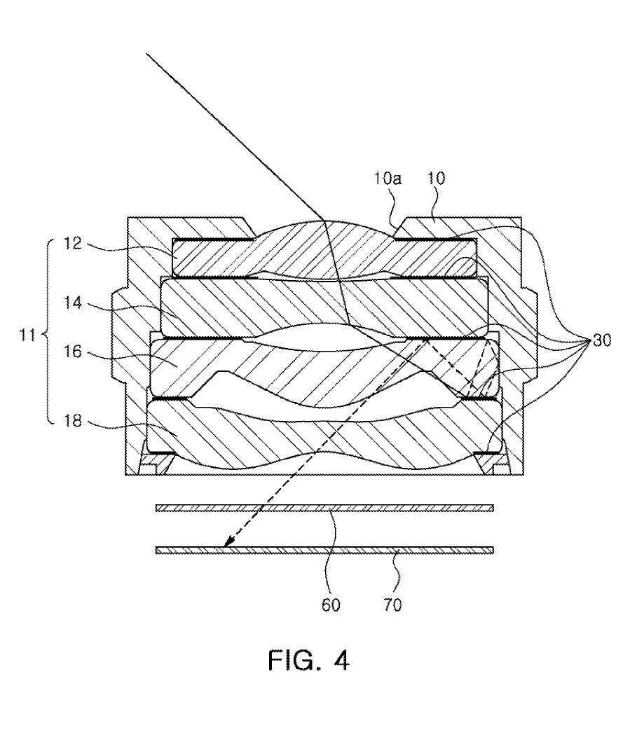

The blocking parts 30 may be provided on upper or lower surfaces of the lenses 11, or both, in a direction in which the lenses 11 are stacked, and may be continuously provided on the surfaces of the rib 50 along the edges of the surfaces of the effective portions of the lenses 11. Therefore, the blocking parts 30 have a ring shape circumscribing the surfaces of the effective portions. Hereinafter, an operation of blocking internal reflection of the rib surfaces of the blocking parts 30 will be described with reference to FIGS. 3 and 4.

FIG. 3 is a schematic cross-sectional view illustrating an example of an operation of blocking parts of the lens assembly blocking internal reflection by rib surfaces of lenses in a case in which light is incident to the lens assembly at an incident angle of 45 degrees. FIG. 4 is a schematic cross-sectional view illustrating an example of an operation of blocking parts of the lens assembly blocking internal reflection by rib surfaces of lenses in a case in which light is incident to the lens assembly at an incident angle of 50 degrees.

Referring to FIG. 3, intense light passing through the first lens 12 accommodated in the lens barrel 10 and having an initial incident angle of 45 degrees, passes through the first lens 12 and then be incident to an effective portion surface of the second lens 14. The intense light incident to the effective portion surface of the second lens 14 may be reflected on the other surface of the second lens 14 opposing an object-side surface of the second lens, and then be incident to the rib surface of the object-side surface of the second lens 14. The object-side of each lens is the side of the lens closest to the lens hole 10a.

Here, a solid line refers to a path of the light, and a dotted line refers to a path of light that is prevented by the blocking part 30. The light incident to the rib surface of the object-side surface of the second lens 14 may again be incident to a rib surface of the other surface of the second lens 14 opposing the object-side surface of the second lens, or the image-side surface of the second lens, and as a result, may be incident to the image formation surface of the image sensor 70.

Since this light causes a flare phenomenon by which resolution is decreased, it is required to be blocked in advance. Therefore, the blocking part 30 is formed on the rib surface of the object-side surface of the second lens 14 to primarily block the light incident to the image formation surface of the image sensor 70. Additionally, some of the light again reflected without being blocked is secondarily blocked by the blocking part 30 formed on the rib surface of the other surface of the second lens 14 opposing the object-side surface of the second lens. In a case in which the light is secondarily blocked, the blocking part 30 is formed on a rib surface of an object-side surface of the third lens 16 to more effectively block the light.

Referring to FIG. 4, intense light passing through the first lens 12 accommodated in the lens barrel 10 and having an incident angle of 50 degrees may pass through the second lens 14 and then be incident to an outer side of an effective portion surface of the third lens 16. Here, a solid line refers to a path of the light, and a dotted line refers to a path of light that is prevented by the blocking part 30.

The intense light incident to the outer side of the effective portion surface of the third lens 16 may be reflected on a rib surface of the other surface of the third lens 16 opposing an object-side surface of the third lens, and then be incident to a rib surface of the object-side surface of the third lens 16. The light incident to the rib surface of the object-side surface of the third lens 16 may again be incident to the rib surface of the other surface of the third lens 16 opposing the object-side surface of the third lens, and as a result, may be incident to the image formation surface of the image sensor 70.

Since this light causes a flare phenomenon by which resolution is decreased, it is required to be blocked in advance. Therefore, the blocking part 30 is formed on the rib surface of the other surface of the third lens 16 opposing the object-side surface of the third lens to primarily block the light incident to the image formation surface of the image sensor 70. However, some of the light may again be reflected without being blocked and is secondarily blocked by the blocking part 30 formed on the rib surface of the object-side surface of the third lens 16.

Although cases in which specific incident angles are 45 degrees and 50 degrees have been described in the above-mentioned examples, the number of lenses provided in the lens barrel 10, refractive indices of the lenses, and the like, may be modified depending on a design of the lens assembly 100. Therefore, the incident angles of light internally reflected on the rib surfaces of the lenses 11 may be modified, and the blocking parts 30 may be formed on rib surfaces of all of the lenses 11 accommodated in the lens barrel 10 in consideration of modifications of the number of lenses 11 and the refractive indices of the lenses 11. Alternatively, when characteristics of the lenses are determined depending on a design of the lens assembly 100, the blocking parts may also be formed only on the rib surfaces of corresponding lenses.

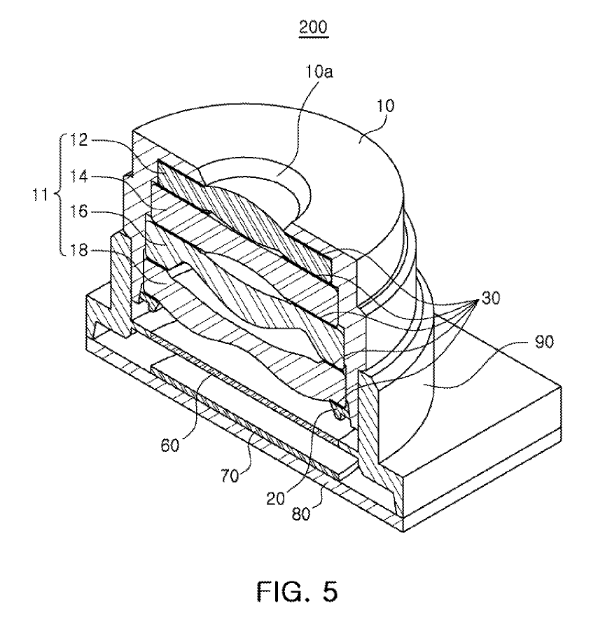

FIG. 5 is a schematic partial cross-sectional view of a camera module according to another example. Referring to FIG. 5, a camera module 200 includes the lens assembly 100 and a housing 90. The housing 90 includes an optical filter 60, an image sensor 70, and a board 80. Since the lens assembly 100 includes the above-mentioned components, a detailed description thereof will be omitted.

The optical filter 60 may be an infrared (IR) cut-off filter, a cover glass, or other filter, provided between the image sensor 70 and a lens adjacent to the image sensor 70. It may be considered that the optical filter does not have an influence on optical performance.

The optical filter 60 serves to block infrared rays and transmit only visible light rays therethrough, preventing noise from occurring in a digital image, and is be mounted for the purpose of high image quality and high resolution. In addition, the optical filter 60 may be provided integrally with the image formation surface of the image sensor 70 corresponding to an image region of the image sensor 70, and may have a rectangular shape corresponding to a shape of the housing 90.

The image sensor 70 includes the image formation surface formed on an upper surface thereof in order to form an image of the light incident through the lenses, and converts the light into electrical signals. A pattern circuit of the image sensor 70 may be electrically connected to the board 80 such as a flexible printed circuit board on which a pattern circuit, a unit for transmitting image signals, is printed.

The image sensor 70 is mounted on an upper surface of a board 80 to be described above by a wire-bonding method. However, a method of electrically connecting the image sensor 70 and the board 80 to each other may be variously modified. The image sensor 70 may be formed of a charge-coupled device (CCD), or a complementary metal-oxide semiconductor (CMOS), in order to sense an image of light passing through the lens 11 and convert the image into electrical signals.

A chip module is mounted in the vicinity of the image sensor 70 on the board 80 using surface-mounting technology (SMT), and the board 80 and the image sensor 70 is electrically connected to each other by wiring bonding after the image sensor 70 is attached to the board 80 by an adhesive. However, a method of electrically connecting the image sensor 70 to the board 80 is not limited to the wire bonding, and may be variously modified depending on the intention of a designer. For example, the image sensor 70 may be adhered to the board 80 using a conductive adhesive.

The housing 90 accommodates the lens barrel 10 therein, and includes the board 80 on which the image sensor 70 having the image formation surface is electrically mounted. The lens barrel 10 and the housing 90 may be coupled to each other by a screwing method in which a screw thread is formed on an outer peripheral surface of the lens barrel 10 and a screw thread groove corresponding to the screw thread is formed on an inner peripheral surface of the housing 90 corresponding to the outer peripheral surface of the lens barrel 10. However, the outer peripheral surface of the lens barrel 10 and the inner peripheral surface of the housing 90 are not limited to being coupled to each other by the screwing method, and may be coupled to each other by an actuator (not illustrated). That is, a method of coupling the lens barrel 10 and the housing 90 to each other may be modified by those skilled in the art understanding the spirit of the present disclosure.

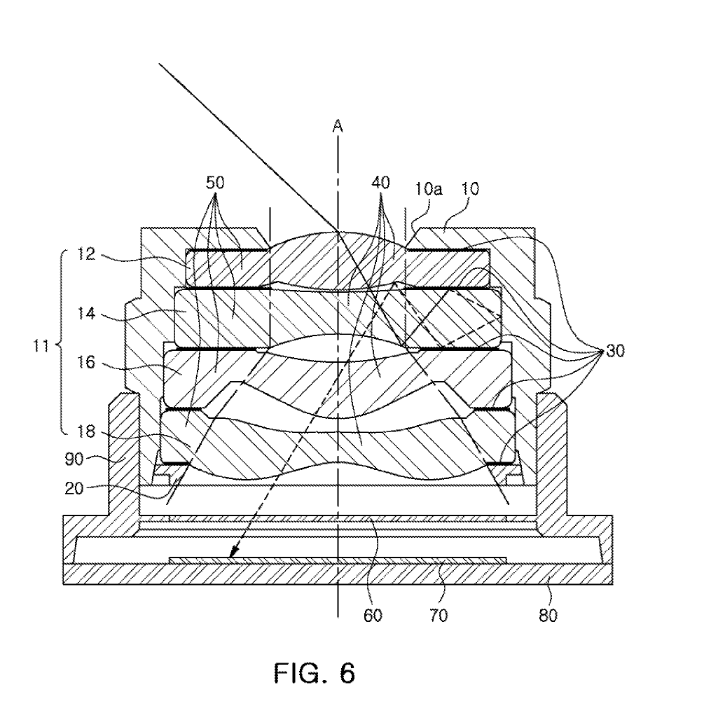

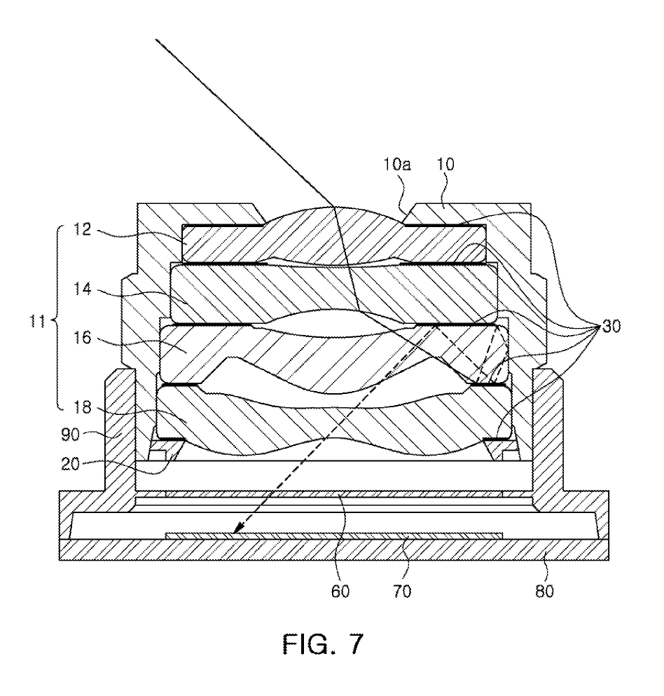

FIG. 6 is a schematic cross-sectional view illustrating an example of an operation of blocking parts 30 of the camera module blocking internal reflection by rib surfaces of lenses in a case in which light having an incident angle of 45 degrees is incident to the camera module; and FIG. 7 is a schematic cross-sectional view illustrating another example of an operation of blocking parts of the camera module blocking internal reflection by rib surfaces of lenses in a case in which light having an incident angle of 50 degrees is incident to the camera module.

Referring to FIGS. 6 and 7, a solid line refers to a movement path of light, and a dotted line refers to a path of light prevented by the blocking part 30. In a case in which light having initial incident angles of 45 degrees and 50 degrees is incident to the camera module, the blocking parts 30 blocks the light incident to the image formation surface of the image sensor 70 through internal reflection of the rib surfaces of the lenses 11.

Here, an operation of the blocking parts 30 of the camera module 200 blocking the light incident to the image sensor 70 through internal reflection of the rib surfaces are the same as that of the blocking parts 30 of the lens module 100 illustrated in FIGS. 3 and 4, blocking the light incident to the image sensor 70 through internal reflection of the rib surfaces. Although the camera module 200 including a predetermined number of lenses having predetermined refractive indices has been illustrated in FIGS. 6 and 7, the number of lenses provided in the lens barrel 10, refractive indices of the lenses, and other characteristics, may be modified depending on a design of the camera module 200.

Therefore, an incident angle of light internally reflected on the rib surfaces of the lens 11 may be modified. Consequently, the blocking parts 30 may be formed on rib surfaces of all of the lenses 11 accommodated in the lens barrel 10 in consideration of modifications of the number of lenses 11 and the refractive indices of the lenses 11.

Alternatively, when characteristics of the lenses are determined depending on a design of the camera module 200, the blocking parts 30 may also be formed only on the rib surfaces of lenses having unwanted internal reflections. As set forth in the examples above, in the lens assembly and the camera module, the incidence of light to the image formation surface of the image sensor through internal reflection by the rib surfaces of the lenses are blocked.

Additionally, a method of preventing internal reflections of light in a lens assembly is disclosed. The method includes stacking lenses along an optical axis in a lens barrel, wherein each of the lenses has an effective portion and a rib extending radially from the effective portion. An axial surface of at least one rib is coated with a light absorbing material. The entire axial surface of the rib may be continuously coated with the light absorbing material.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens assembly comprising:
a lens barrel comprising an internal space;
lenses stacked in the internal space of the lens barrel,
wherein each of the lenses has an effective portion and a rib extending in a radial direction from an outer radial edge of the effective portion; and
a blocking part is provided on an axial surface of at least one rib.

2. The lens assembly of claim 1, wherein the blocking part is disposed on upper and lower surfaces of the rib.

3. The lens assembly of claim 1, wherein the blocking part is continuously disposed on the surface of the rib along the edge of an effective portion surface.

4. The lens assembly of claim 1, wherein the blocking part has a ring shape circumscribing an effective portion surface.

5. The lens assembly of claim 1, wherein the blocking part is formed of matte ink.

6. The lens assembly of claim 5, wherein the blocking part is formed by an inkjet printing method or a laser printing method.

7. The lens assembly of claim 5, wherein the matte ink includes a carbon based material, a chrome based oxide a copper based oxide, a manganese based oxide, a cobalt based oxide, a cobalt based sulfide, a nickel based oxide, or any combination thereof.

8. The lens assembly of claim 1, further comprising a lock ring inserted into the lens barrel to fix the lenses,
wherein the lock ring contacts the surface of the rib and an inner peripheral surface of the lens barrel.

9. The lens assembly of claim 1, further comprising:
a first lens adjacent to a lens hole of the lens barrel, comprising a first rib;
a second lens adjacent to the first lens, comprising a second rib;
a third lens adjacent to the second lens, comprising a third rib; and
a fourth lens adjacent to the third lens, comprising a fourth rib.

10. The lens assembly of claim 15, wherein the blocking material is disposed only on an upper surface and a lower surface of the second rib, third rib or both.

11. The lens assembly of claim 1, wherein the blocking portion is a light absorbing material.

12. A camera module comprising:
a lens assembly comprising:
a lens barrel comprising an internal space;
lenses stacked in the internal space of the lens barrel,
wherein each of the lenses has an effective portion and a rib extending in a radial direction from an outer radial edge of the effective portion; and
a blocking part is provided on an axial surface of at least one rib;
an image sensor having an image formation surface configured to receive light passing through the lenses; and
a housing accommodating the lens barrel therein.

13. The camera module of claim 12, wherein the housing is provided with an optical filter configured to filter light passing through the lenses.

14. A method of preventing internal reflections of light in a lens assembly comprising:
stacking lenses along an optical axis in a lens barrel, wherein each of the lenses has an effective portion and a rib extending radially from the effective portion; and
coating an axial surface of at least one rib with a light absorbing material.

15. The method of claim 14, further comprising:
coating the axial surface of the at least one rib with an inkjet printing or a laser printing.

16. The method of claim 14, wherein the entire axial surface of the rib is continuously coated with the light absorbing material.
